(19) United States
(12) Patent Application Publication
(10) Pub. No.: US 2011/0047881 A1
(43) Pub. Date: Mar. 3, 2011

(54) WINDOW ASSEMBLY

(76) Inventors: Eirik Bjørn, Ringkobing (DK); Torben Hundevad, Ringkobing (DK); Ulla Toft Østergaard, Silkeborg (DK); Esben Brun Nielsen, Ringkobing (DK); Niels Peter Christensen, Ringkobing (DK); Stefan Madsen, Ringkobing (DK)

(21) Appl. No.: 12/736,280

(22) PCT Filed: Mar. 26, 2009
(86) PCT No.: PCT/EP2009/053631

§ 371 Date: Nov. 12, 2010

(30) Foreign Application Priority Data
Mar. 26, 2008 (EP) 08153351.5

(51) Int. Cl. E06B 3/36; E05D 7/00

(52) U.S. Cl. 49/399; 49/400; 49/401

(57) ABSTRACT

An outwardly opening window assembly (1) for mounting in a window opening (27), said window assembly comprising: a plate element (4), a window sash (3) comprising a top sash element (3a), a bottom sash element (3c) and two side sash elements (3b,3d), said window sash elements arranged at the periphery of said plate element, a window frame (2) comprised of a top frame member (2a), a bottom frame member (2c) and two side frame members (2b,2d), said window frame members arranged at the periphery of said window sash when the window assembly is closed, a mounting fitting (5,6) which connects at least one of the window sash elements (3b) to at least one of the window frame members (2d). One of the window frame members (2c) comprises a first surface (25) which faces towards the outside of the window assembly and where one of the window sash elements (3c) comprises a second surface (36) and a third surface (45), said second surface being arranged such that it is located on the inner side (44) of the plate element and such that it is facing said first surface (25) of said frame member when the window is closed and said third surface being arranged such that it is facing the outer periphery (27) of the window assembly and where said mounting fitting being fastened to said frame member via said first surface (25) and to said sash member via said third surface (45). In this way, a window assembly is provided which is advantageous in a number of ways.

The current invention relates to an outwardly opening window assembly which is suitable for mounting in a window opening, said window assembly comprising a plate element, a window sash comprising a top sash element, a bottom sash element and two side sash elements, said window sash elements arranged at the periphery of said plate element, a window frame comprised of a top frame member, a bottom frame member and two side frame members, said window frame members arranged at the periphery of said window sash when the window assembly is closed and a mounting fitting which connects at least one of the window sash elements to at least one of the window frame members.

This description should represent the vast majority of outwardly opening window assemblies currently available and should not in general be limiting to the scope of protection of the claims. The plate element could take many different forms, for example a single, double, triple pane of glass. The plate element could also be a blind plate element used to prevent light from passing through the plate element. A window sash is arranged around the plate element to hold the plate element. The window frame is arranged in the window opening and the window sash is connected to the window frame via mounting fittings. Usually the frame member is the outermost element (towards the periphery of the window assembly) of the window assembly, but in certain cases, the sash element could overlap the frame member. The window assembly could take many different forms, for example, top hinged, side hinged, reversible, fixed, etc.

Depending on the form of the window assembly, the mounting fittings will be different. For example, in a top or side hinged window assembly, the mounting fittings are typically single axis hinges with pure rotation of the sash with respect to the frame or linkage hinges with both rotation and displacement of the sash with respect to the frame. If the window assembly is a fixed window assembly where the sash is fixed to the frame such that the window cannot be opened, the mounting fittings can be of a different type. Also, a reversible window assembly will comprise mounting fittings which are part of a reversible window mechanism.

In cases where the window assembly is made to be opened and closed, for example side and top hinged window assemblies, locking fittings will typically be provided to lock the window in the closed position and/or in the open position. Locking fittings could take many forms. One typical example is an espagnolette mechanism. Usually the mounting fittings and the locking fittings are separate entities, but in certain window assemblies, one could imagine that the mounting fittings and locking fittings were combined into a single fitting, with two separate functions.

A possible definition of a mounting fitting which covers mounting fittings for windows which are openable, is a fitting which allows the window sash to move in a controlled manner with respect to the window frame. In a controlled manner could be understood as moving along a predetermined motion path. For example a hinge allows motion about a predetermined axis.

It should be noted that a fixed window assembly is a special embodiment of a window assembly which should also be encompassed by the current specification. Even though a fixed window assembly is not really meant to be opened and closed, it is still considered an outwardly opening window assembly which is just locked most of the time. However, if necessary, a fixed window assembly can still be opened by unlocking the mounting/locking fittings.

### DESCRIPTION OF RELATED ART

Outwardly opening window assemblies of the kind mentioned above are well known in the art. Some examples of such window assemblies are disclosed in WO 07/090394 A1, WO 05/028799 A1, WO 04/027193 A1, EP 0 311 701, EP 0 548 531 and WO 02/053863 A1. Common design goals when designing a window assembly of the above mentioned kind are high thermal resistance, high strength, low production costs, low height, simple and straightforward installation and a visually appealing design. These design goals are met with varying degrees of success by the currently available window assemblies.

### SUMMARY OF THE INVENTION

One aspect of the current invention is therefore to provide a window assembly which fulfills the above mentioned design goals in a way which is better and/or different than the prior art assemblies.

This aspect is provided by a window assembly as mentioned in the introductory paragraph where one of the window frame members comprises a first surface which faces towards the outside of the window assembly and where, one of the window sash elements comprises a second surface and a third surface, said second surface being arranged such that it is located on the inner side of the plate element and such that it is facing said first surface of said frame member when the window is closed and said third surface being arranged such that it is facing the outer periphery of the window assembly and said mounting fitting being connected to said frame member via said first surface and to said sash member via said third surface.

It should be mentioned that in the current specification, the terms used to describe the window are meant to be understood according to a window assembly when mounted in a wall opening of a typical house. For example, the phrase “faces towards the outside of the window assembly” should be understood as facing towards the outside of the window assembly when the window assembly is mounted in an outer wall of a house. The terms “inside” and “outside” should be interpreted as being inside and outside the house respectively. The terms “inner surface” and “outer surface” should be understood as a surface which is close to the inside of the house and a surface which is close to the outside of the house respectively. The term “periphery” should be understood as the outer perimeter of the window assembly. For example, “facing the outer periphery” should be understood as facing along a direction which goes from the centre of the window towards the outer edge of the window assembly. It should be noted that all surfaces in the window construction in some way face the periphery of the window assembly, however, within this specification, the phase “facing the outer periphery” should be understood as facing away from the centre of the window assembly.

Furthermore, it should be noted that many surfaces are angled and therefore have a normal vector having components which point in two different directions. For example a surface could have a normal vector which has a component which faces towards the centre of the window assembly and a component which faces the outside of the window assembly. In order to define the surfaces more precisely, outwardly/inwardly facing surfaces are those surfaces which have a normal vector arranged at an angle of between 45 and 90 degrees to the plane of the window assembly and centre/periphery facing surfaces are those which have a normal vector arranged at an angle of between 0 and 45 degrees to the plane of the window assembly.

In the claims, it is stated that the second surface is facing the first surface. This should be understood in that the two surfaces are located opposite from each other. The surfaces do not however have to be completely parallel or overlapping. However, a vector normal to the first surface should point towards the second surface and a vector normal to the second surface should point towards the first surface.

The term “surface” should be understood rather broadly and according to its common meaning, in other words a surface of an element. It does not have to be completely planar or flat. However, the term surface should not be interpreted unnecessarily broadly. It should be clear for the person skilled in the art that an object has a number of surfaces which can be uniquely identified. In most cases, each uniquely identifiable surface has a particular function which separates it from the other surfaces. The surface is not necessarily planar, but could have different grooves or protrusions, for example a dovetail groove, formed on the surface. However, it is clear to the author of this specification that the term “surface” can be interpreted in many different ways. It is therefore important that when interpreting the meaning of the claims, that the understanding of the term “surface” should match with the way in which it is used in the current specification.

In the claims is it furthermore stated “mounting fitting being connected to the frame member via the first surface”. This should be understood in the light of this specification. It is not necessarily the surface which is bearing the loads transferred by the mounting fittings. It furthermore doesn't mean that the element which defines the surface is bearing the loads. Just that the fittings are in contact with the surface and that the fastening means for fastening the fitting to the frame or sash pass through the surface. For example, the first surface could be the surface of a thin plastic flange which is glued onto a wooden frame member. The mounting fittings are placed on the surface of the thin plastic flange and screws are inserted through the plastic flange and into the wooden frame member behind the plastic flange. Therefore, the mounting fittings are in contact with the first surface, but the loads are carried by the wooden element behind the thin plastic flange.

Additional features and embodiments of the window assembly are disclosed in the dependent claims. Additional inventions are disclosed in the additional independent claims.

A number of additional terms used in the claims are defined here for the sake of clarity. An outwardly protruding flange is a flange which protrudes away from an element in a direction towards the outside of the window assembly. An inwardly protruding flange is a flange which protrudes away from an element in a direction towards the inside of the window assembly. The outermost edge of an object is that edge which is closest towards the outside of the window assembly. The width of the sash element is defined as the distance taken along a vector which is perpendicular to the plane of the window assembly and taken between the outermost surface of the sash element and the innermost surface of the sash element. Co-planar is meant to be two elements which lie on essentially the same plane. Essentially, is defined as being as close to the stated criteria as possible such that the invention is fulfilled. For example, if two elements are said to be essentially co-planar, then the elements should be on the same plane, but if they are slightly away from the same plane, but still fulfill the objective of the invention, then they should still be considered to be co-planar. For example, it should be clear to the person skilled in the art that in most window assemblies, there are manufacturing tolerances which will mean that the window assembly cannot be manufactured exactly as designed.

An integrated U-shaped recess is a recess which is formed in a single piece of material and is not comprised of multiple elements joined together. For example, all window sashes have a U-shaped recess which holds the glass pane in the window sash. However, some windows use a L shaped sash member and a glazing bead to hold the window in place. This defines a U-shaped recess, but does not define an “integrated” u-shaped recess since multiple elements make up the U-shaped recess. The same is true for the term “integrally formed”. Integrally formed is defined as being made from a single piece of material.

It should be emphasized that the term “comprises/comprising” when used in this specification is taken to specify the presence of stated features, integers, steps or components but does not preclude the presence or addition of one or more other features, integers, steps, components or groups thereof. For example, in the claims, it is stated that “one of the window frame members comprises . . . ”. This should be understood by the person skilled in the art as “at least one of the window frame members comprises . . . ”. Another example is that the claims comprise “a mounting fitting”, but this should again be understood as “at least one mounting fitting”.

### BRIEF DESCRIPTION OF THE DRAWINGS

In the following, the invention will be described in greater detail with reference to the embodiments shown by the enclosed figures. It should be emphasized that the embodiments shown are used for example purposes only and should not be used to limit the scope of the invention.

FIG. 1 shows a first perspective view of an embodiment of a complete outwardly opening side hinged window assembly according to the current invention.

FIG. 2 shows a second perspective view of the window assembly shown in FIG. 1.

FIG. 3 shows a partial cross section of the window assembly of FIG. 1 taken on a plane which is perpendicular to the longitudinal axis of the frame member and the sash element. The figure shows a portion of a frame member, a portion of a sash element and a portion of a two paned plate element.

FIG. 4 shows a cross section view of the corner hinge, frame member and sash member according to the line IV-IV defined in FIGS. 1 and 2.

FIG. 5 shows a schematic view of a mitre joint between two sash elements.

FIG. 6 shows a perspective detailed view of one embodiment of a corner hinge which is used in the window assembly of FIGS. 1 and 2.

FIG. 7 shows an exploded perspective view of the hinge of FIG. 6.

FIG. 8 shows a perspective detailed view of one embodiment of a centre hinge which is used in the window assembly of FIGS. 1 and 2.

FIG. 9 shows an exploded perspective view of the centre hinge of FIG. 8.

FIG. 10 shows a detailed side view of the centre portion of the locking mechanism shown in FIGS. 1 and 2 in the locked position.

FIG. 11 shows a detailed side view of the centre portion of the locking mechanism shown in FIG. 10 but without the housing so that the inner workings of the mechanism can be seen.

FIG. 12 shows a detailed side view of the centre portion of the locking mechanism shown in FIG. 11 but in the open position.

FIG. 13 shows a perspective detailed view of the centre portion of the locking mechanism shown in FIG. 10.

FIG. 14 shows an exploded perspective view of the centre portion of the locking mechanism shown in FIG. 10.

FIG. 15 shows an exploded perspective view of the procedure used to mount the locking mechanism in a sash member.

FIGS. 16-18 show respectively a perspective view, a top view and a side view of a locking plate to which the centre locking mechanism of FIG. 10 locks when the window assembly of FIGS. 1 and 2 is closed.

FIG. 19 shows a perspective view of a corner locking plate to which the bolts of the locking mechanism lock when the window assembly of FIGS. 1 and 2 is closed.

FIG. 20 shows a perspective view of the top sash element and a window brake mechanism.

FIG. 21 shows an exploded perspective view of the window brake mechanism of FIG. 20.

FIG. 22 shows a cross section view of the window brake mechanism of FIG. 20 according to the line XXII-XXII defined in FIG. 20.

FIG. 23 shows a cross section view of the window brake mechanism of FIG. 20 in the “unlocked” position and according to the line XXIII-XXIII defined in FIG. 20.

FIG. 24 shows a cross section view of the window brake mechanism of FIG. 20 in the “locked” position and according to the line XXIII-XXIII defined in FIG. 20.

FIG. 25 shows a schematic view of a compound window assembled according to one aspect of one of the inventions of the current specification.

FIG. 26 shows a cross section view of two frame members joined together in a compound window.

FIG. 27 shows a partial cross section of a second embodiment of a window assembly according to the current invention taken perpendicular to the longitudinal axis of the frame member and the sash element. The figure shows a portion of a frame member, a portion of a sash element and a portion of a two paned plate element.

FIG. 28 shows a partial cross section of a third embodiment of a window assembly according to the current invention taken perpendicular to the longitudinal axis of the frame member and the sash element.

FIG. 29 shows a partial cross section of a fourth embodiment of a window assembly according to the current invention taken perpendicular to the longitudinal axis of the frame member and the sash element.

FIG. 30 shows a partial cross section of a fifth embodiment of a window assembly according to the current invention taken perpendicular to the longitudinal axis of the frame member and the sash element.

FIG. 31 shows a partial cross section of a sixth embodiment of a window assembly according to the current invention taken perpendicular to the longitudinal axis of the frame member, the sash element and the hinge.

FIG. 32 shows a partial cross section of a prior art embodiment of a window assembly taken perpendicular to the longitudinal axis of the frame member and the sash element.

### DETAILED DESCRIPTION OF THE EMBODIMENTS

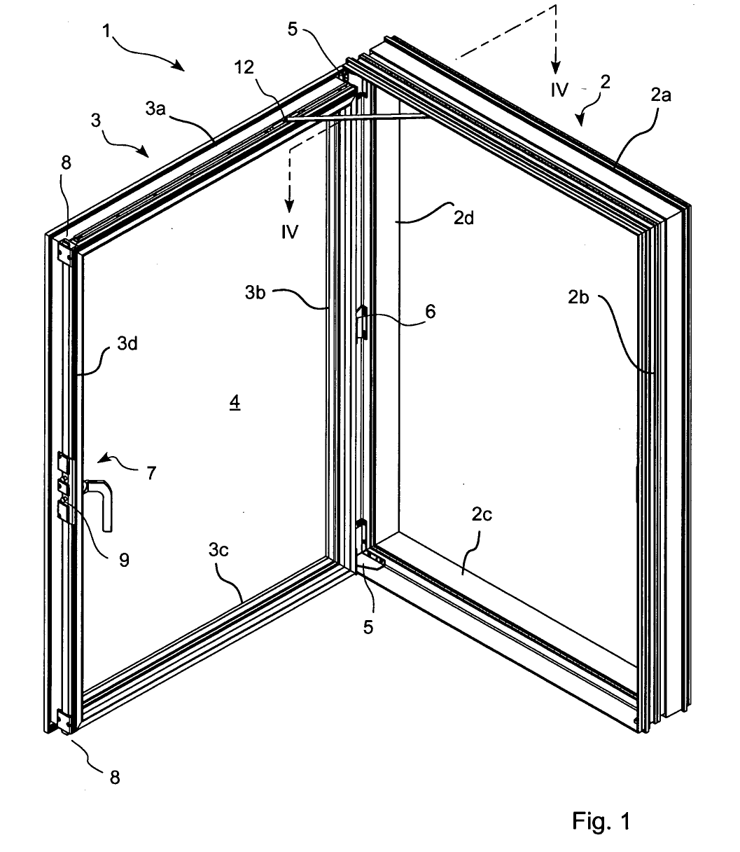

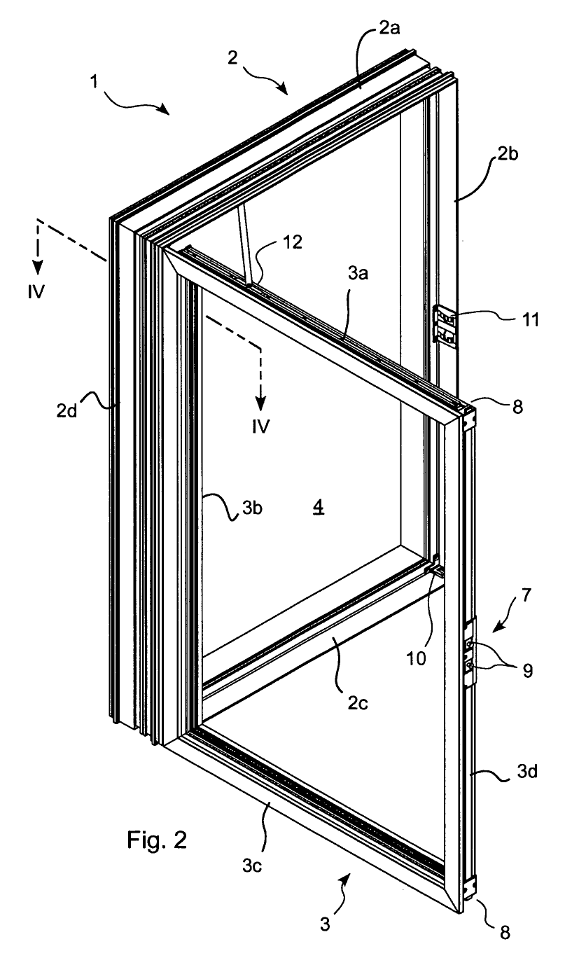

FIGS. 1 and 2 show an outwardly opening side hinged window assembly 1 according to the current invention in two different perspective views. The window assembly comprises a window frame 2 made up of four frame members 2a, 2b, 2c, 2d connected together with mitre joints, a window sash 3 made up of four sash elements 3a, 3b, 3c, 3d connected together with mitre joints and a triple glazed pane of glass 4 arranged inside the window sash 3. Two corner hinges 5 and a centre hinge 6 connect the sash 3 to the frame 2. More details of the hinges will be presented later on in this specification.

An espagnolette mechanism 7 is used to lock the window sash in the closed position. The espagnolette mechanism 7 comprises a centre section 7 which displaces two espagnolette bolts 8 in opposite directions such that they protrude from the outer edges of the sash. The centre section 7 also comprises two mushroom cams 9 which are also displaced in opposite directions. The espagnolette bolts engage with striking plates 10 which are mounted at the corners of the frame when the window assembly is closed and the mushroom cams engage with a striking plate 11 mounted at the centre of the frame when the window assembly is closed. More details of the espagnolette mechanism 7 will be presented later on in this specification.

A window brake device 12 is mounted on the top sash element and is activated by the displacement of the upper espagnolette bolt 8 of the espagnolette mechanism 7. The window brake device 12 is arranged such that the window is held in the open position when the locking mechanism 7 is in the locked position. When the locking mechanism 7 is put into its unlocked position, the window brake device 12 allows the window sash 3 to freely open and close. More details of the window brake device are presented later on in this specification.

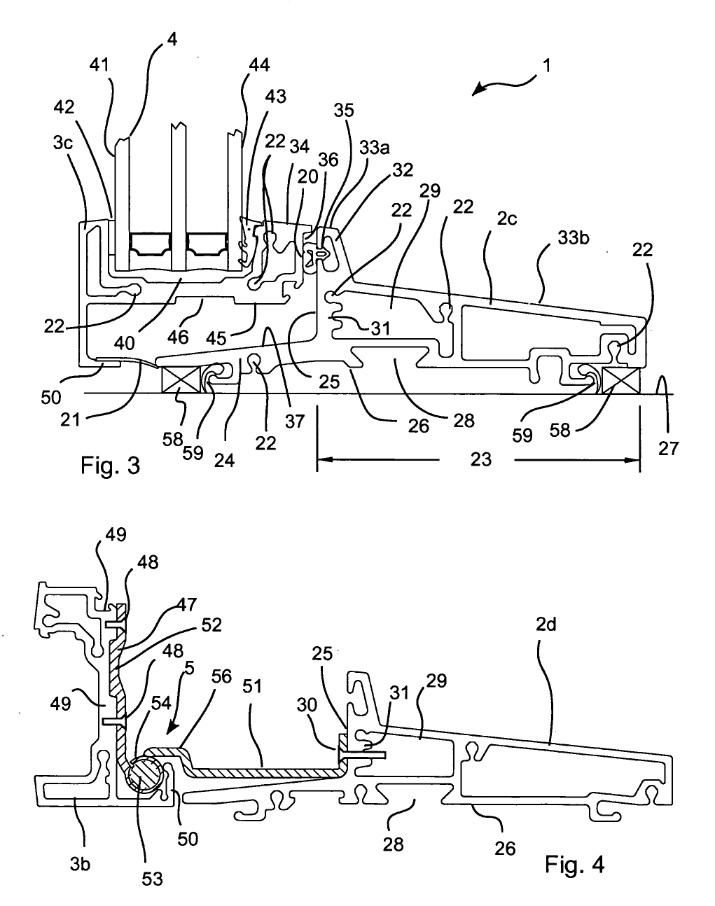

FIG. 3 shows a cross section through the window assembly 1 of FIGS. 1 and 2 when the window is closed. In addition to the elements described in regards to FIGS. 1 and 2, FIG. 3 shows a number of additional details. In order to seal the construction, a number of seals are arranged in the assembly. A first seal element 20 is attached to the frame member 2 to seal the innermost opening between the sash and frame. A second seal 21 is attached to the sash 3 and seals the outermost opening between the sash and the frame. The second seal is in the form of a flexible flap which is attached to the sash member along one edge. It should be noted that the first and second seals effectively seal a chamber between the sash and the frame. This sealed chamber is the chamber where the mounting fittings and locking fittings can be arranged. The seals therefore prevent the mounting/locking fittings from too much exposure to the outside environment. In addition, the seals prevent frequent air exchange with the outside environment from cooling the inside of the window assembly. This increases the thermal resistivity of the window assembly.

In the current embodiment, the frame member 2 and the sash element 3 are manufactured via a pultrusion process and are made from a polyurethane based matrix with glass fibres which for the most part are arranged along the longitudinal axis of the profiles. In a preferred embodiment, 80-85% of the material is comprised of glass fibres which run along the longitudinal axis of the profiles. This type of material has a finer surface finish than typical glass fibre materials. Should it be necessary or desirable, the visible surfaces could be painted to achieve a certain aesthetic impression.

It has also been discovered that the thermal conduction properties of this polyurethane/glass fibre material are about ⅔s less than traditional GRP materials. This gives a significant increase in the thermal resistance of the complete window assembly. While the above embodiment has been described with glass fibres it should be mentioned that the fibres can be made from different types of materials and different mixes of materials in order to give the resulting composite material different properties.

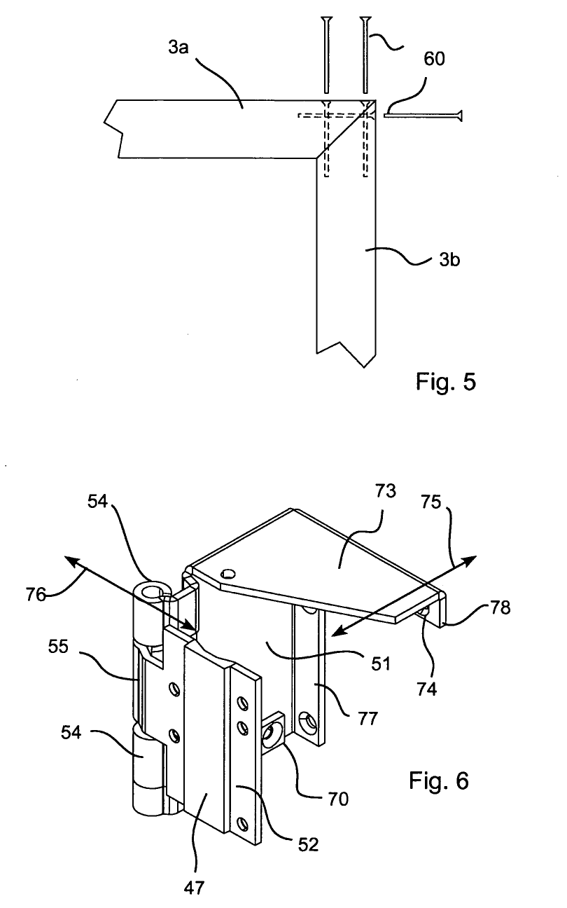

The frame and sash elements both comprise a number of screw holes 22. The screw holes are arranged as cylindrical channels which run the entire length of the profiles and which have centre axes which are arranged parallel to the longitudinal axis of the profiles. The screw holes 22 are used to connect the profile elements to each other in a mitre joint with screws arranged in the screw holes. The procedure for connecting the elements in a mitre joint is described in more detail with regards to FIG. 5.

The frame member has a main body portion 23 which is the part of the frame member which is located on the inner side of the sash element 3 and an outwardly protruding flange 24 which projects from the main body portion 23 towards the outside of the window assembly and underneath the sash element. The main body portion is the part of the frame member which gives strength to the window frame assembly. One purpose of the flange is to extend the front of the frame member as far out towards the outside of the window assembly as possible in order to make it easier to apply a sealant bead 58 between the frame member and the window opening 27 after the window assembly has been installed in the window opening. A seal 59 can be clipped onto the lower side of the frame member in order to act as a stop for the sealant material. The seal 59 extends from the lower surface of the frame member and engages with the window opening. Another purpose of the flange is as mentioned before, to allow the cavity in which the mounting fittings are arranged to be sealed from the outside environment.

In window assemblies having frame members which do not extend very far out towards the outside of the window assembly, it is necessary to remove the window sash in order to apply the sealant bead properly. With the current frame member, it is possible to apply a sealant bead with the window sash in place. It should be noted that the flange 24 does not have to be made particularly strong since its primary purpose is for sealing. In the current embodiment, the outwardly protruding flange is essentially horizontal, but this could be changed in other embodiments. It can also be seen that in comparison to the height of the main body portion of the frame member (dimension parallel to the plane of the window assembly), the height of the outwardly protruding flange is quite small. In the particular embodiment, the height of the protruding flange is less than 30% of the height of the main body portion.

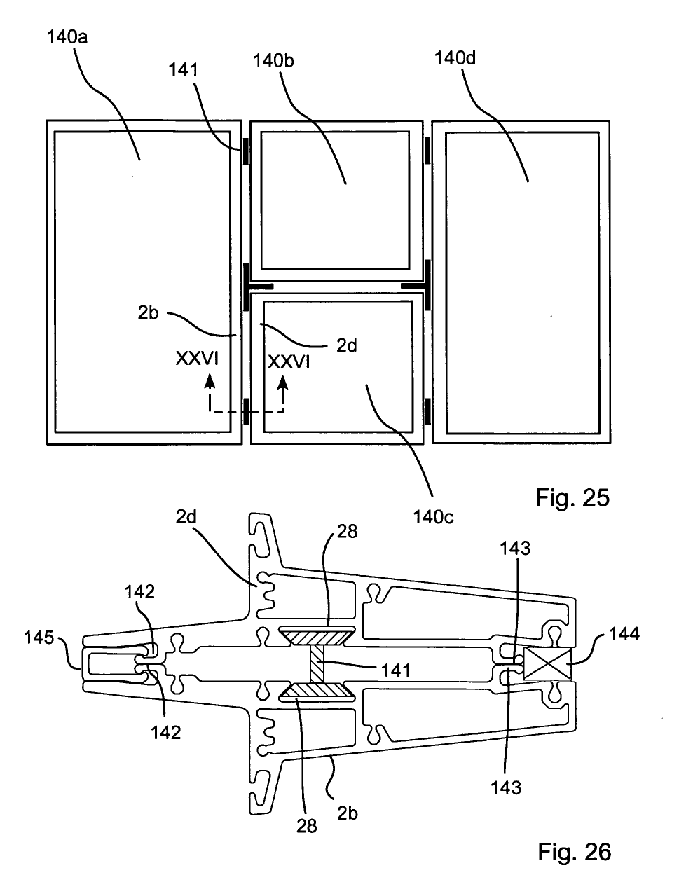

The main body portion has a front surface 25 which faces the sash element 3. The main body portion also has a lower surface 26 which faces the periphery of the window opening 27 when the window assembly is installed in a window opening. On the lower surface, a dovetail groove 28 is formed. The dovetail groove can be used to attach the frame members 3 to the window opening via a bracket (not shown). The dovetail groove can also be used to attach a frame member to another frame member of a window assembly arranged beside the frame member when building compound windows. This arrangement is described in more detail with regards to FIGS. 25 and 26.

As can be seen from FIG. 3, the front surface 25 is one surface of a box shaped portion 29 of the main portion of the frame member. The dovetail groove 28 is arranged on another one of the surfaces of the box shaped portion. As can be seen in FIG. 4, mounting fittings 5 such as hinges can be mounted to the frame member by screwing screws 30 into the front surface (25) of the frame member. In this way, loads from the mounting fittings can be supported by the box shaped portion of the frame member. In this way, the loads transferred to the box shaped portion by the mounting fittings can be lead on to the dovetail groove very effectively. In this way, there is a relatively short connection distance between the mounting fittings and the window opening. This reduces the stresses in the frame member. It can be noted from the figures, that the box shaped portion 29 is hollow. But it can also be noted that the wall 31 of the box shaped portion which forms the front surface 25 of the box shaped portion is thickened. This increases the strength of the frame member at the point where the mounting fittings are screwed into the frame member. It should be noted that the sash element and frame members shown in FIGS. 3 and 4 show two different embodiments which are slightly different to each other.

It can also be noted that the front surface 25 of the main body portion is arranged more to the outside of the window assembly than the dovetail groove 28. This is beneficial since the dovetail groove can be made larger without filling up the chamber in which the mounting and locking fittings are attached. This gives more space to the mounting and locking fittings without making the frame thicker.

The frame member 2 furthermore has a protrusion 32 arranged on top of the box shaped portion 29. The protrusion 32 extends upwards away from the box shaped portion of the main body portion of the frame member and towards the centre of the window assembly. The upper surface 33 of the protrusion is arranged flush with the upper surface 34 of the sash element. A seal element 20 is arranged in a recess 35 in the protrusion which seals the connection between the innermost inwardly facing surface 36 of the sash and the frame member. It can be seen that due to the protrusion 32, there is a smooth transition between the sash element 3 and the frame member 2 when the window is closed. If the protrusion were not there, there would be a more abrupt transition between the sash element and the frame member. It can also be said that the upper surface 33 of the protrusion and upper surface 34 of the sash element are arranged such that the distance, in a direction which is parallel to the plane of the window assembly, from the centre of the window assembly to the outermost edge of surface 33 is essentially the same as the distance, in a direction which is parallel to the plane of the window assembly, from the centre of the window assembly when the sash is closed to the innermost edge of the surface 34.

Furthermore, it can be imagined that if the frame member were arranged such that its entire upper surface 33a,33b were arranged flush with the upper surface 34 of the sash element, then the overall visual impression of the frame member would be rather massive. By lowering a portion of the the upper surface 33b of the frame member, the frame member appears smaller and is less intrusive. This is especially true if two frame members are attached together back to back as is the case in compound windows. This will be shown and described later on in more detail with regards to FIGS. 25 and 26.

It can also be seen that the forwardly protruding flange 24 and the protrusion 32 are integrated with the rest of the frame member. In this way, there are no connections between different elements in the frame member. This increases the weather resistance of the frame member since water or other foreign substances cannot enter the frame member. In many other frame members comprising a forwardly protruding flange, the forwardly protruding flange is made as a separate element which is attached to the main body portion of the frame member. In these types of assemblies, water can force its way between the flange and the main body portion of the frame member. This is not possible with the current embodiment. It can also be said that the surface 37 of the forwardly protruding flange 24 which faces towards the centre of the window assembly is integrated with the outwardly facing surface 25 of the frame member.

The sash element 3c comprises an integrated U-shaped channel 40 in which the window pane 4 is arranged. The window pane 4 in this embodiment is a triple glazed window pane. The outer/outside surface 41 of the window pane is attached to the inwardly facing surface of the U-shaped channel of the sash element via a strip of double sided tape 42. A rubber seal element 43 is pressed into the gap between the inner surface of the window pane and the outwardly facing surface of the U-shaped channel of the sash element on the inner/inside surface 44 of the glass pane. It should be noted that since the sash comprises an integrated U shaped profile around the window pane, the thermal expansion of all the parts of the sash element surrounding the window pane are the same. This reduces the stresses in the sash when the window assembly is exposed to very warm or very cold temperatures. In addition, the integrated U-shaped profile of the sash gives a great deal of strength to the sash since the sash is not comprised of multiple discreet elements which are fastened together as is the case with most traditional window sashes. In typical window sashes, the window pane is held in place on one side of the pane by the sash element and on the other side of the sash by a glazing bead mounted on the sash element.

As shown in FIG. 4, the sash element is arranged such that the mounting fittings are attached to the sash via the surface 45 which faces the periphery 27 of the window assembly and the periphery of the window opening 27. A groove 46 is formed in the surface into which a corresponding protrusion 47 on the mounting fitting is arranged. This increases the contact surface between the mounting fitting and the sash and also increases the strength of the connection between the mounting fitting and the sash. Screws 48 are used to attach the mounting fitting to the sash. The screws are placed through thickened portions 49 of the lower surface 46 of the sash. It should also be noted that the lower surface 46 of the sash is located closer towards the outside of the window assembly than the outwardly facing surface 25 of the frame member.

The sash element also comprises a rearwardly pointing or inwardly protruding flange 50. The rearwardly pointing flange 50 is arranged at the same height as the forwardly pointing flange 24 of the frame member when the window is closed. In this way, the two flanges are co-planar and almost touch each other. In the current embodiment there is a gap of around 8 mm between the two flanges. A rubber seal 21 is attached to the rearwardly pointing flange in order to seal the gap. Due to the construction of the frame members and the sash elements, the area/cavity in which the mounting fittings are arranged is entirely enclosed and protected from the weather.

FIG. 4 shows the frame member 2 and the sash member 3 in cross section together with one of the hinges 5 which in this specification is considered a mounting fitting. More details of the hinges are described in the discussion with regards to FIGS. 6-9. The hinges transfer the weight of the window sash to the window frame. When the window is open, the majority of the forces due to the weight of the window sash are transferred to the window frame via the hinges.

As can be seen from the figure, the hinge comprises a first flange 51 which is fastened to the frame member and a second flange 52 which is fastened to the sash element. The flanges are fastened to the sash and frame members respectively with screws 30, 48. However, other forms of fastening could also be imagined. As can also be seen from the figures, the dimension of the flanges in the direction which is perpendicular to the plane of the window assembly is quite large. This is due to the fact that the point of rotation of the sash is located quite far forward with respect to the surface 25 of the frame member to which the hinge flange 51 is fastened. This is in contrast to other types of window assemblies where the hinges are much smaller but are attached much more forward on the frame members. In the current embodiment, large demands are therefore placed on the strength of the mounting fittings. This is however easily achieved with strong materials such as high strength steel. In the other types of window assemblies, large demands are placed on the frame members. This is usually solved, either with a thick frame member which is visually non-appealing or with a very strong forward portion of the frame member. This strong forward portion however makes the frame member rather expensive since the strong forward portion typically extends the entire length of the frame member. In the current embodiment, the forwardly protruding flange is relatively weak and the hinges are very strong. Therefore strength is placed only there were it is necessary.

The two flanges are connected together with a pin 53 arranged in at least one cylindrical element 54,55 attached one to each flange. The cylindrical elements are arranged with their longitudinal axes aligned with the pivot axis of the window assembly. The flanges of the hinge are arranged such that in the closed position of the window, the parts of the flanges which are closest to the cylindrical element are formed such that they are offset from a plane which goes through the pivot axis of the hinge in a direction towards the centre of the window assembly. For example, the first flange is formed with a U-shaped portion 56 where a portion of the U-shaped portion is arranged offset from a plane going through the pivot axis of the hinge. The second flange is attached to the cylindrical portion of the hinge such that the entire flange is offset from a plane going through the pivot axis of the hinge. Due to this offset, the inwardly pointing flange of the sash element can be made large without having the inwardly pointing flange interfering with the flanges of the hinge when the window is opened.

As mentioned previously, the sash element and the frame member have a number of screw holes 22 which are used to join adjoining sash or frame members at the corners of the sash and frame members via a mitre joint. This is shown schematically in FIG. 5. The sash or frame members are cut at 45° such that they fit together in a mitre joint. Holes (not shown) are then drilled in the outer surface of the sash or frame members in line with the screw holes of the adjoining sash element or frame member. A screw 60 can then be inserted through the hole and screwed into the screw hole. The screws can be of the self tapping kind such that it is not necessary to form the screw holes with a thread in advance.

From FIG. 3, it can be seen that the frame member 2 has four screw holes 23 and that the sash element 3 has three screw holes 23. When joining the frame members at a corner, it will therefore be advantageous to put two screws in from one side and two screws in from the other side. When joining the sash elements at a corner, it will be advantageous to put two screws in from one side and one screw in from the other side. The case of the sash element is shown in FIG. 5.

It can also be seen from FIG. 3, that the screw holes do not lie along a single linear line. In the prior art where screw holes are used to assemble mitre joints, a strengthening member in the form of an angle bracket is typically inserted in a slot in the two elements to be joined before the screws are inserted to fasten the elements together. In these types of structures, the screws only serve to hold the elements together, not to give, for example, torsional strength to the joint. However, in the current embodiment, by arranging the elements such that they have at least three screw holes and such that the longitudinal axes of the screw holes do not lie on a single plane, a great deal of strength, both tensile and torsional strength, can be supplied to the joint by the screws. In this way, a strengthening member in the form of an angle bracket is not necessary. This makes the construction simpler and also makes the window assembly easier to assemble.

It can also be seen from the figures that the screw holes are located close to the outer surfaces of the profiles. The further out the screw holes are placed, the greater the strength of the connections. In addition, the further out the screw holes are placed, the nicer the connection between two elements will appear. It can also be mentioned that the sash and frame can be disassembled at a later point in time if desired by unscrewing the screws in the corners. This is in contrast to other types of windows where the corners are welded or glued together.

Since the sash member is made with an integrated U-shaped channel 40 in which the glass pane 4 is arranged, it is not possible to assemble the sash first and then put the glass pane into the sash afterwards. In contrast to this many other types of window assemblies use a glazing bead to hold the window pane in place in a pre-assembled window sash. In the case of the current embodiment, it is necessary to build the sash around the glass pane. There are many different ways of doing this, but one method is described here.

The glass pane is supported in a fixed position. Glass pane supporting blocks (not shown) are arranged in the bottom of the u-shaped channel of the bottom sash element and a strip of double sided tape 42 is applied to the outermost side of the U-shaped channel. This outer most side faces in towards the inside of the window assembly. The bottom sash element is then placed on the bottom edge of the glass pane until the glass supporting blocks are in contact with the bottom edge of the glass pane. The bottom sash element is placed as far towards the outside of the window as possible in order to ensure that the strip of tape does not come into contact with the glass pane. Tape strips are then applied to the remaining sash elements and the sash elements are then placed on the remaining edges of the glass pane. Again, it should be noted that the sash elements are placed such that the tape strips do not come into contact with the outer surface of the glass pane. Once the sash elements are correctly placed, the sash elements are joined together via screws in the corners as shown in FIG. 5. Once the sash has been correctly joined together, the assembled sash is pushed towards the inside of the window assembly such that the tape strips come into contact with the outer surface of the glass pane. In this way, the sash elements are firmly fixed to the glass pane. The tape strips also act as a form of seal between the outer surface of the window and the sash. A seal element 43 is then pressed into the gap between the inner surface 44 of the glass pane and the outwardly facing surface of the U-shaped channel of the sash element 3. The seal element 44 is a rubber seal which is able to absorb the dimensional tolerances in the window pane. It should be noted that even though there are relatively large dimension tolerances in the thickness of the window pane, the outer surface of the window pane will always be located at the same location due to the tape. Therefore all of the tolerance will be absorbed by the rubber seal 44. However, since most of the loads on the window pane are absorbed by the tape, the fit between the seal 44, the sash 3 and the window pane does not have to be as tight as in other types of window constructions where the window pane is held in the sash by the friction created by mechanically squeezing the edge of the window pane between the sash and a glazing bead.

It should be noted that in certain cases, additional glass supporting blocks (not shown) might be necessary on the sides and/or the top of the glass pane. These glass supporting blocks should be able to absorb the dimensional tolerances in the sash and in the glass pane as well as to prevent sag. In other cases, it might be that additional glass supporting blocks are not necessary on the side and/or the top of the glass pane. The tape 42 will to a certain extent take the place of the supporting blocks.

It can also be noted that the strips of tape could take different forms. In one embodiment, a paper cover on the tape is removed after the sash has been assembled, but before the sash is pushed onto the glass pane. In another embodiment, the paper cover is removed before the sash element is placed on the edge of the glass pane. In a third embodiment, the act of placing the sash element over the edge of the window pane, peels a layer of paper off of the tape thereby exposing the sticky part of the tape.

It should be noted that the frame and sash profiles used along the four sides of the window pane in the above described embodiment are all the same. The sealed chamber is therefore also the same along all four edges of the window assembly. This decreases the complexity of the window assembly since only one type of frame profile and one type of sash profile is used per window assembly. Also, since the sealed chamber is the same, the mounting fittings and locking fittings can be made from similar shapes and sizes.

In the above description, one embodiment of a method for assembling the window sash on the window pane has been described. However, other methods will also be possible.

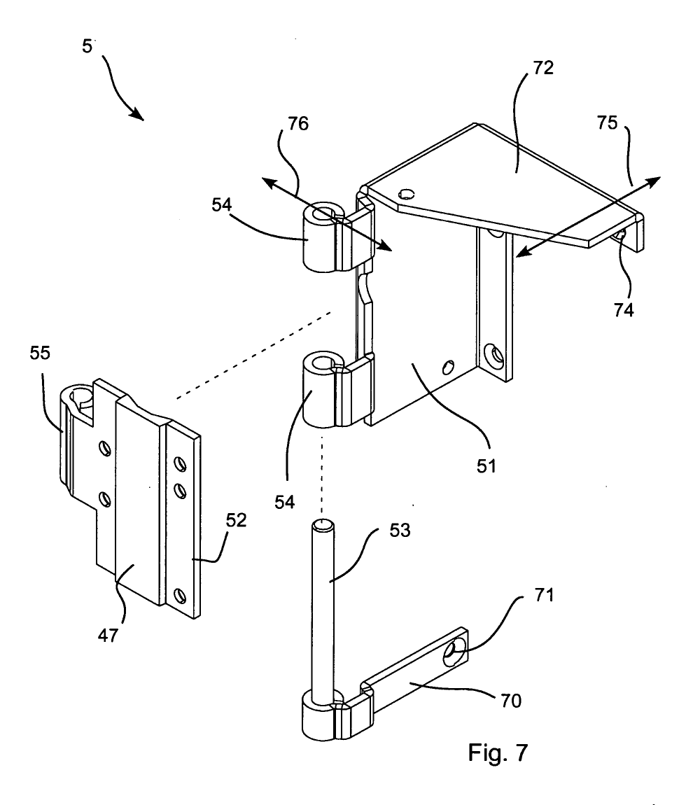

FIGS. 6 and 7 show more details of the corner hinges 5 used in the current embodiment. The hinges comprise, as was described previously, two flanges 51, 52 where a first flange 51 is attached to the frame member 2 and a second flange 52 is attached to a sash element 3. The first flange comprises two cylindrical elements 54 attached at one end of the flange and the second flange comprises one cylindrical element 55 attached at one end of the flange. The two cylindrical elements of the first flange are arranged one on either side of the cylindrical element of the second flange. A pin 53 is inserted through the cylindrical elements to allow the two flanges to pivot with respect to each other.

The pin 53 of the current embodiment is formed as an elongated cylindrical element which is sized to fit inside cylindrical channels of the cylindrical elements 54, 55 of the flanges. A mounting flange 70 is attached to the pin at one end and extends away from the pin as a sort of elongated handle. The mounting flange serves two purposes. The first purpose is to make it easier to manually place the pin in the cylindrical elements. Due to the small amount of space available between the flanges of the hinge and due to the small amount of space between the frame members and sash elements, it can be difficult to mount the pin manually, especially for people having large fingers. The flange makes it possible to easily guide the pin into the correct position. The person mounting the hinge will hold the pin via the flang and via the flange guide the pin into the hole. The second purpose is to secure the pin once it has been mounted. The flange is therefore formed with a hole 71 through which a screw (not shown) can be placed. The screw can be used to attach the mounting flange of the pin to the first flange of the hinge. In this way, the pin is secured so that it cannot fall out. In addition, the flange also secures the pin in the case of an attempted break in. Since the axis of the screw is parallel with the plane of the window assembly, it is necessary for the window to be open in order to access the screw. When the window is in the closed position, it is impossible to get access to the screw and a thief will not be able to simply remove the pin of the hinge to gain access to the window.

Since the hinge shown in FIGS. 6 and 7 is to be mounted at the corner of the window assembly, it comprises a third flange 72 which is integrated with the first flange and at a right angle thereto. The third flange can therefore be attached to a second frame member 2a at the corner. In this way, the corner hinges are connected to both frame members 2a, 2d at the corner. This allows the weight of the window sash to be transferred to both frame members. It also strengthens the joint between the frame members.

From the figures, it can also be seen that the first flange has a fourth flange 77 which is arranged perpendicular to the first flange and is arranged at the end of the first flange which is opposite the end of the first flange to which the cylindrical elements 54 are connected. The third flange furthermore comprises a fifth flange 78 which extends perpendicular to the third flange.

The fourth 77 and fifth 78 flanges are arranged co-planar. Screws are placed through the fourth and fifth flanges to attach the hinge to the two frame members arranged at a corner of the frame. The fourth and fifth flanges are as shown in FIG. 4 fastened to outwardly protruding surfaces of the frame members which are arranged on the inside of the sash elements. In this way, a thin frame profile can be provided without decreasing the strength of the hinge.

The third flange 73 can also be used to adjust the position of the pivot axis of the hinge. An adjusting screw (not shown) can be placed in the outermost hole 74 of the third flange (or more precisely the fifth flange 78 of the third flange (73)). By adjusting this screw so that the third flange moves in and out, as shown by the arrow 75, the pivot axis of the hinge can be displaced along an axis which is parallel to the plane of the window assembly and parallel to the third flange as shown by the arrow 76. This adjustment possibility is especially interesting in the top hinge of a side hung window since it will allow the hinge to be adjusted to compensate for the sag of the window sash over time.

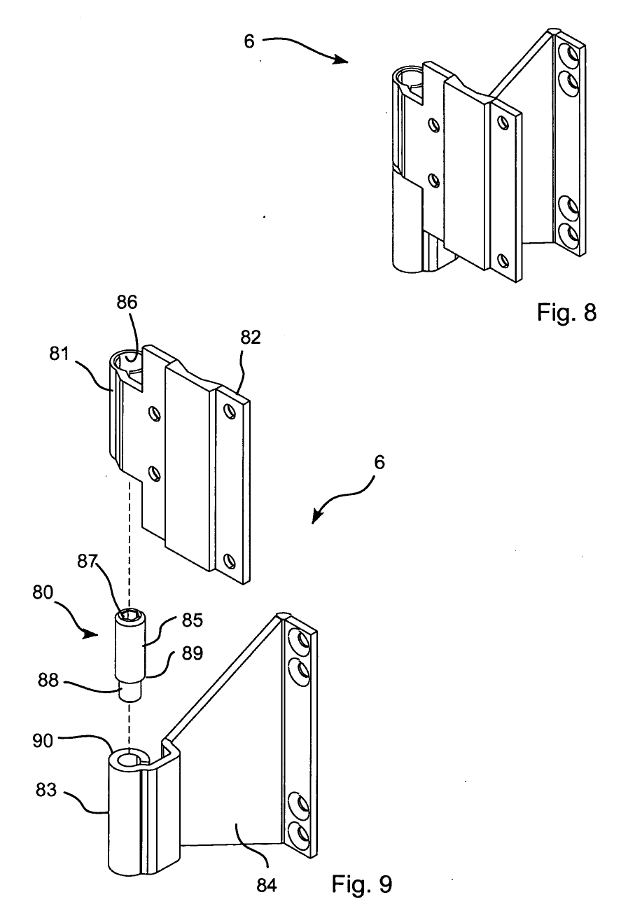

The centre hinge 6 shown in FIGS. 8 and 9 is similar to the corner hinge 5 shown in FIGS. 6 and 7. However, instead of a pin which is inserted through the cylindrical elements of the hinges, a pin 80 is adjustably mounted in the cylindrical element 81 of the flange 82 which is connected to the sash element. The cylindrical element of this flange is arranged above the cylindrical element 83 of the flange 84 which is connected to the frame member. The pin comprises an outside threaded portion 85 which is arranged in an inside threaded portion 86 of the cylindrical element 81 of the sash flange 82. By rotating the pin with a hex key in the hex recess 87 in the top of the pin 80, the pin can be moved up or down in the cylindrical portion 81 of the sash flange 82. The lower end 88 of the pin has a reduced diameter with respect to the outer threaded portion 85 of the pin. The shoulder 89 between the lower end 88 and the threaded portion 85 of the pin rests on the upper surface 90 of the cylindrical portion 83 attached to the flange 84 attached to the frame member. This allows the height of the sash to be adjusted with respect to the frame.

As with the corner hinges, the portion of the flange which is closest to the cylindrical portion has been offset from a plane which goes through the pivot axis of the hinge. Again, this allows the rearwardly protruding flange 50 of the sash element to rotate without interfering with the hinge flanges. The centre hinge 6 is attached to the sash element and the frame member in the same way as the corner hinge shown in FIG. 4. In addition, the sash flange has a protrusion 91 which is engaged with the shallow recess 46 in the sash element. This again increases the strength of the connection between the hinge and the sash.

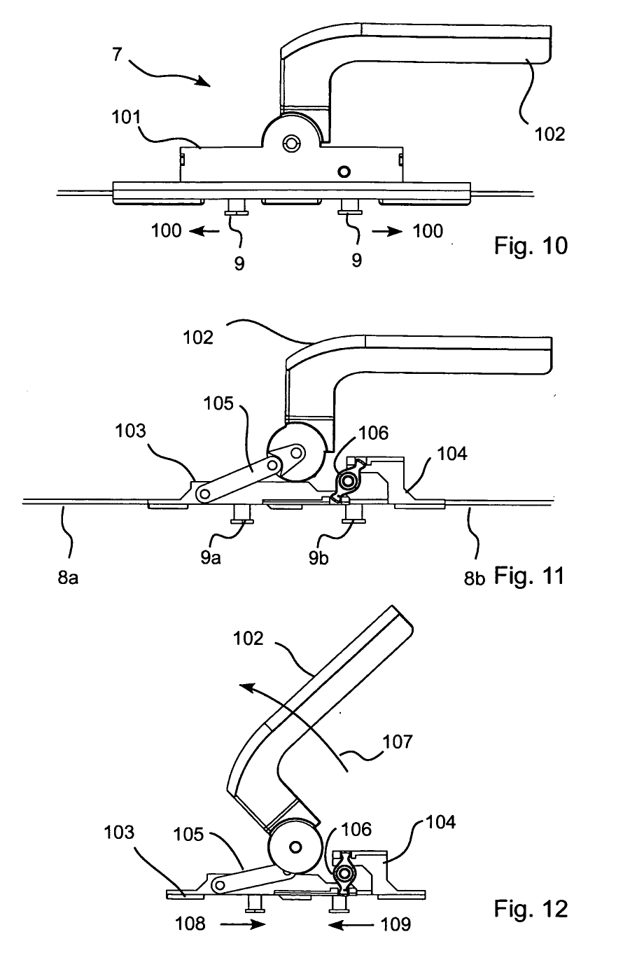

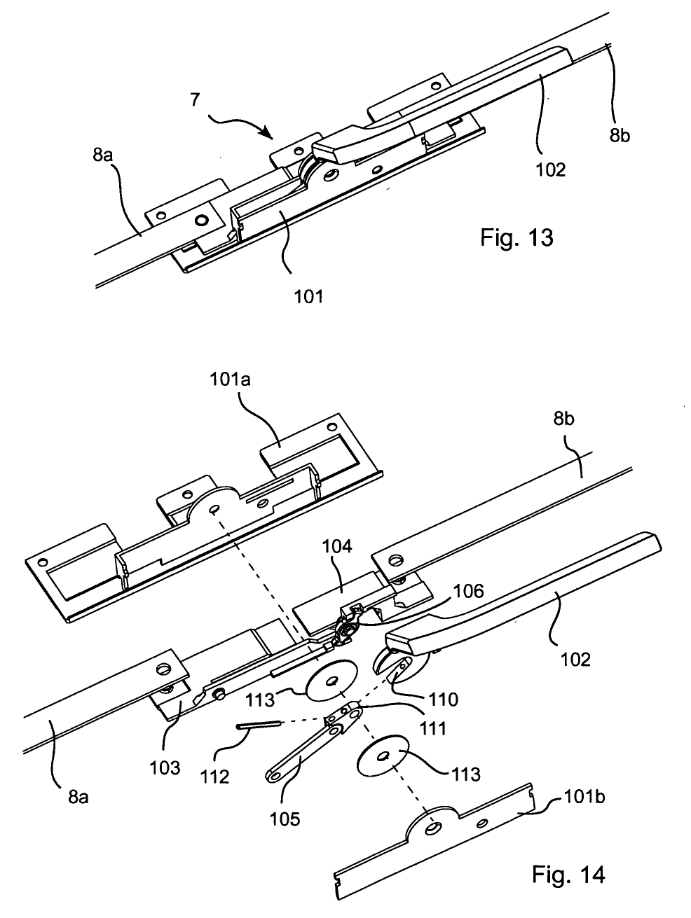

FIGS. 10-15 show different views of the centre portion 7 of the locking mechanism. In this embodiment of the window assembly, the locking mechanism is an espagnolette mechanism as can be seen in FIGS. 1 and 2. The espagnolette mechanism has two espagnolette bolts 8 which are moved outwards when the window is to be locked by the centre mechanism. The centre mechanism also comprises two mushroom cams 9 which are also arranged to be displaced outwards as shown by the arrows 100 when the locking mechanism is locked.

As can be seen from FIGS. 1 and 2, the espagnolette bolts are arranged as rods having a rectangular cross section. As can be seen the longitudinal axes of the bolts are arranged along the outer edge of the sash element. In this particular embodiment, the bolts are arranged visibly on the outer edge of the sash element, but they could also be integrated inside the sash element in an other embodiment. In the case where the bolts are visible, they could be made from the same material as the sash element. This will give a good visual impression.

The bolts 8 are also arranged such that the cross section of the bolts has a rectangular shape with one dimension being larger than the other dimension. The larger dimension is arranged perpendicular to the plane of the window assembly and the smaller dimension is arranged parallel to the plane of the window assembly. In this way, the bolt does not protrude out from the window sash very much. Furthermore, since the large dimension of the cross section of the bolt is arranged perpendicular to the plane of the window assembly, the strength of the bolt in the direction which would be exposed to large forces during an attempted break-in will be very large. It should be noted that the bolts are shown as a single element in the figures which are connected to the centre locking mechanism and which engage with the striking plates on the frame when locked. However, it could also be imagined that each of the bolts were arranged as an elongated member and a bolt, where the bolt is arranged to engage with the striking plate and the elongated member is arranged to connect the bolt with the centre locking mechanism. In this way, the bolt could be made from metal and the elongated portion could be made from a composite material.

As can be seen from FIGS. 10-15, the centre section of the locking mechanism comprises a housing 101, a handle 102, a first displaceable portion 103, a second displaceable portion 104, a link 105 pivotably connected to the first displaceable portion and the handle and a gear 106 for transferring the motion of the first displaceable portion to the second displaceable portion. The handle is pivotably arranged in the housing. As the handle pivots counter clockwise with respect to the figures as shown by the arrow 107 in FIG. 12, the link 105 of the linkage is pulled to the right in the figures as shown by the arrow 108 in FIG. 12. The first displaceable portion is therefore displaced to the right. A gear 106 in the form of a pivotable element with two arms protruding from a centre pivot point is arranged such that one of the two arms is placed in a recess in the first displaceable element. The second of the two arms is placed in a recess in the second displaceable element. As the first displaceable element moves to the right, the pivotable element rotates counter clockwise with regards to the figures.

The second displaceable element is therefore moved to the left as shown by the arrow 109 in FIG. 12.

It should be noted that the pivotable element 106 takes the place of a toothed gear wheel usually used in mechanisms of this type. The use of a pivotable element with two arms instead of a toothed gear wheel results in a number of advantages. A first advantage is that the mechanism cannot be assembled incorrectly. Another advantage is that the arms of the pivotable element can be made stronger than the teeth of a toothed gear wheel.

A first espagnolette bolt 8a and a first mushroom cam 9a are connected to the first displaceable element 103 and a second espagnolette bolt 8b and a second mushroom cam 9b are connected to the second displaceable element 104. As the displaceable elements are displaced, the respective espagnolette bolts and mushroom cams are also displaced.

It should be noted from the figures, that in the closed position of the centre mechanism as shown in FIG. 11, the longitudinal axis of the link 105 of the linkage mechanism is arranged such that it is arranged on the opposite side of the line which connects the pivot point between the handle and the link and the pivot point between the link and the first displaceable portion when compared to the position in the open position of the centre mechanism as shown in FIG. 12. In this way, the centre mechanism is self locking whereby it is not possible to force the handle to rotate into an open position by pushing on the espagnolette bolts or the mushroom cams when the centre mechanism is in the locked position. By forcing the espagnolette bolts or the mushroom cams in the locked position of the window, the handle will try to rotate to an even more locked position.

As can be seen from FIG. 14, the handle 102 has a wedge shaped recess 110 which is engaged with a correspondingly shaped wedge shaped element 111 which is pivotably arranged in the housing 101. When the handle is engaged with the wedge shaped element 111, a splint 112 is pressed through an opening in the handle and the wedge shaped element. This holds the handle firmly attached to the wedge shaped element. By removing the splint, the handle can be removed from the centre mechanism and exchanged with another handle. Washers 113 are arranged on either side of the wedge shaped element. The washers are made from a relatively soft material so that there will be a certain amount of friction between the housing and the handle. This will give a better feel to the movement of the handle. This better movement will give a feeling of good quality to the user.

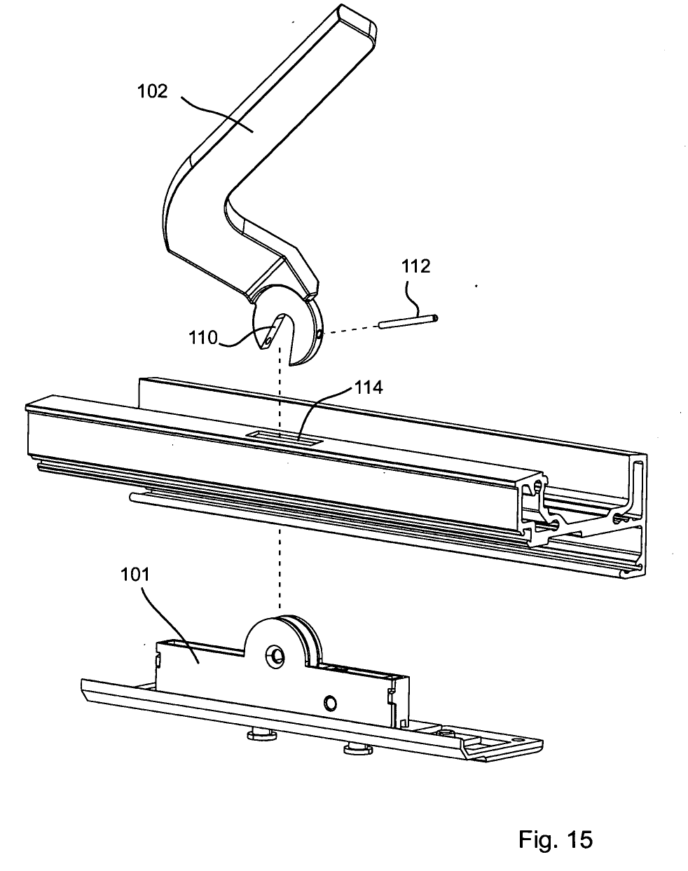

As can be seen from FIG. 15, the centre portion of the locking mechanism is arranged to be attached to the sash element by first inserting the housing of the locking mechanism through a hole in the sash element from below the sash element and then inserting the handle into the hole 114 in the sash element from the top of the sash element. Once the handle element is in place, a splint 112 is inserted through the handle element which holds the handle element firmly on the housing. In this way, it is possible to later on change the handle if desired. It should be noted, that when the handle is rotated to the closed position, the pin is not visible and cannot be removed. Due to this, if the handle is to be removed, it must first be rotated to the open position of the locking mechanism.

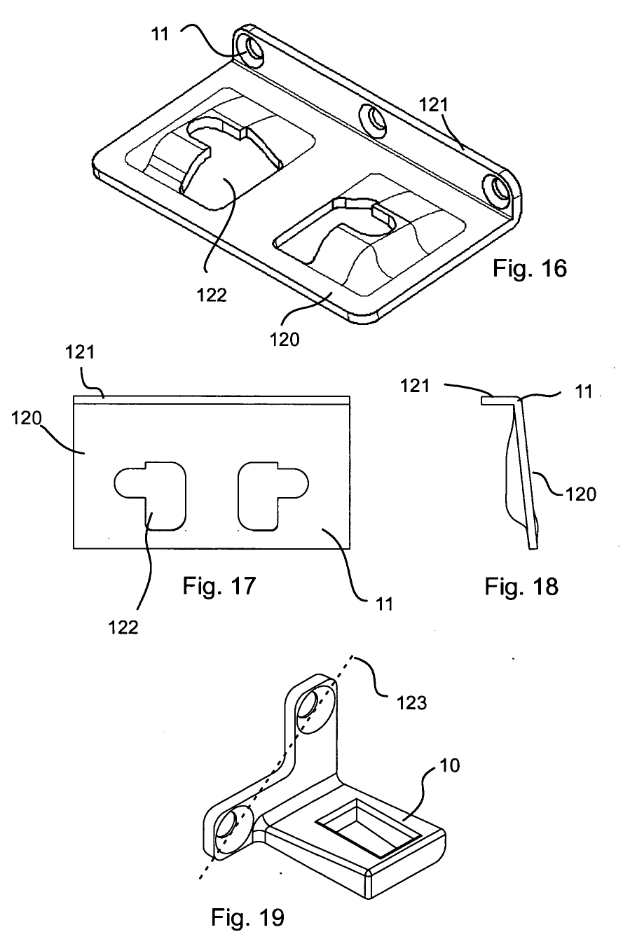

FIGS. 16-18 show details of the centre striking plate 11 of the locking mechanism. As can be seen from the figures the striking plate comprises a first flange 120 and a second flange 121 which are arranged at an angle to each other. The second flange is mounted to the outwardly facing surface 25 of the frame member 2 and the second flange comprises L-shaped 122 recesses for fastening on to the mushroom cams 9 of the centre mechanism. Since the centre mechanism is arranged to displace the mushroom cams outwardly when locked, the striking plate is formed with two L shaped recesses 122 where the L's are arranged back to back, such that the base portions of the L's point away from each other. The advantage of having two mushroom cams which move away from each other in the closed position, is that the strength of the window assembly against break in is increased. When trying to force one mushroom cam away from the striking plate, the other mushroom cam will be pressed more in to the striking plate. It can also be seen that due to the arrangement of the striking plate, in the case where the window assembly is attempted to be forced open, the striking plate will bend such that it is even more locked. Also, the forces which are applied when attempting to force the window open are arranged such that the striking plate is exposed to tensile forces arranged in a direction in which the striking plate is very strong. The forces are transferred directly back to the frame member. In this way, the locking mechanism is very strong.

The striking plate 10 shown in FIG. 19 is arranged at the corner of the window assembly. As with the corner hinges, the corner striking plate is also attached to both frame members at the corner via screws (not shown). This again increases the strength of the joint and allows the forces applied to the striking plate to be split between the two frame members. The striking plate is also arranged such that if force is applied during a break in attempt, the striking plate will bend about the line 123 which connects the two mounting screws and the striking plate will bend into a even more locked position.

It should be noted that in both the centre striking plate 11 and the corner locking plate 10, only a single locking position is provided for. However, as will be known to the person skilled in the art, it is also possible to provide the striking plates with two recesses. In this way the window can be locked in a slightly open position or it can be locked in a fully closed position.

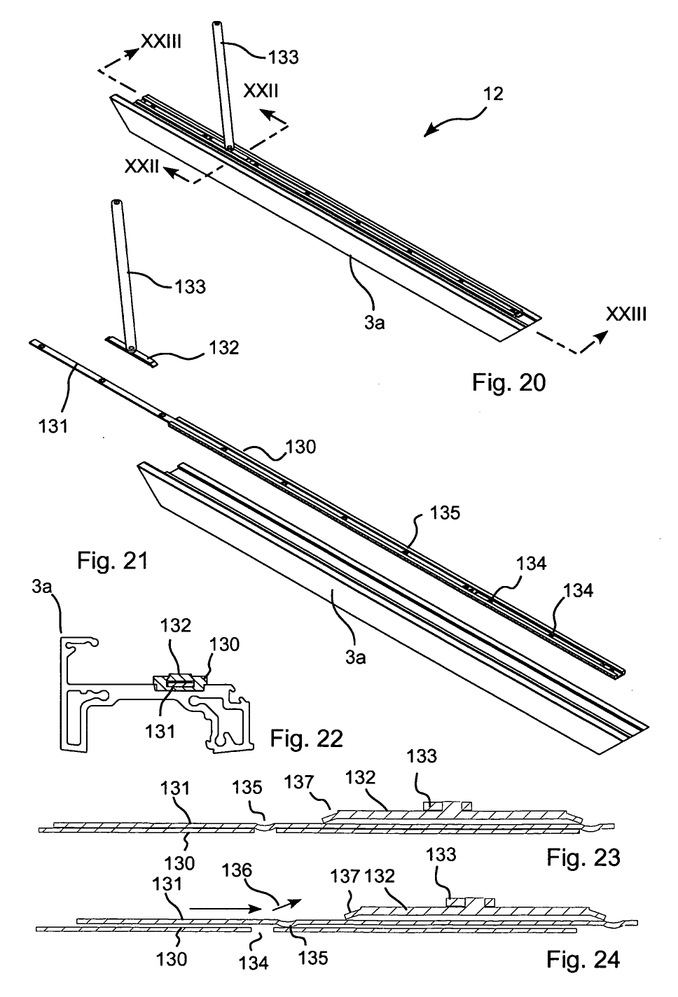

FIGS. 20-24 shows different views of a window brake mechanism 12. The window break mechanism is comprised of a guiding track 130, a first sliding element 131 and a second sliding element 132 arranged in the guiding track. The first sliding element 131 is arranged to extend along a greater portion of the guiding track and the second sliding element is arranged to be connected to a rotation arm 133 which is pivotably connected at one end to the window frame. As the window opens and closes, the second sliding element is displaced along the guiding track. The first sliding element is connected to the top espagnolette bolt 8a via a piece of bent spring steel (not shown) which transfers the motion of the espagnolette bolt around the corner of the sash. As the espagnolette bolt is moved up and down, the motion is transferred to the first sliding element which is displaced back and forth along the guiding track.

The guiding track is formed with holes 134 arranged in the bottom surface of the track at regular spaced intervals. The first sliding element 131 is arranged with circular protrusions 135 on the bottom surface of the element and arranged at the same regular spaced intervals as the holes in the guiding track. In the open position of the locking mechanism, the protrusions of the first sliding element are arranged in the holes of the guiding track as shown by the cross section shown in FIG. 23. As the locking mechanism is put into the locked position, the first sliding element is displaced and the protrusions are forced out of the holes as shown by the arrows 136 in FIG. 24. Due to the slope of the protrusions, the sliding element is displaced upwardly away from the guiding track. This forces the second sliding element to be squeezed between the first sliding element and the guiding track. In this way, the second sliding element is prevented from sliding along the guiding track. This holds the window in the position in which it is placed. This position is shown in FIG. 24.

The second sliding element is furthermore formed with downwardly bent flanges 137 which act as springs which force the second sliding element away from the first sliding element. This allows the mechanism to take up slack as the contact surfaces between the different sliding elements get worn.

It should be noted that in the current embodiment, the first sliding element was formed with protrusions and the guiding track was formed with depressions. However, the opposite could also be imagined. It should also be noted that in the current embodiment, the motion of the brake mechanism is linear instead of rotary as is the case in many other forms of window brake devices. This simplifies the construction since the linear motion of the espagnolette mechanism does not first have to be translated into a rotary motion.

FIGS. 25 and 26 show a way of building compound window assemblies from multiple individual window assemblies 140a, 140b, 140c, 140d. In FIG. 25, four different window assemblies are joined together into a compound window with four window panes. As can be seen from the figure, each window assembly is a complete self contained window assembly similar to the one shown in FIGS. 1 and 2. The window assemblies could be side hung, top hung, fixed, reversible, etc. Fittings 141 are used to connect the frame member of one window assembly with the frame member of an adjoining frame assembly.

FIG. 26 shows details of the connection between two adjacent frame members 3b, 3d. The frame members are arranged such that each frame member has two protrusions 142,143 arranged at opposite sides of the frame member. When the two frame members are joined together, the two protrusions of the first frame member push up against the two protrusions of the second frame member. In this way, the frame members are in contact with each other only at the two protrusions. A fitting 141 is arranged in the dovetail grooves 28 of the two frame members which pulls the frame members towards each other. Due to this arrangement, the frame members will be tightly joined together, independent of all the geometrical tolerances in the frame members.

The protrusions also serve as stops for a sealant bead 144 inserted into the connection between the frame members. Or a plastic clip 145 can be inserted into the groove between the frame members to finish the assembly in a neat and tidy way. It should be noted that in a construction such as this one, there will always be geometrical tolerances between the different window assemblies. The current solution allows these tolerances to be absorbed in a simple and strong way. It can also be noted that since the fittings are inserted in the dovetail grooves of the frame members and due to the strength of the frame members, it is not necessary to have any supporting mullions as is the case with other types of compound window assemblies and/or curtain walls. The frame members themselves can support the window structure.

It should be noted that in the current embodiment, the two protrusions 142 are integrated with the frame member. However, it could also be imagined that the frame member defines a smooth lower surface and that protrusions are mounted to the lower surface of the frame member before the window assemblies are joined together.

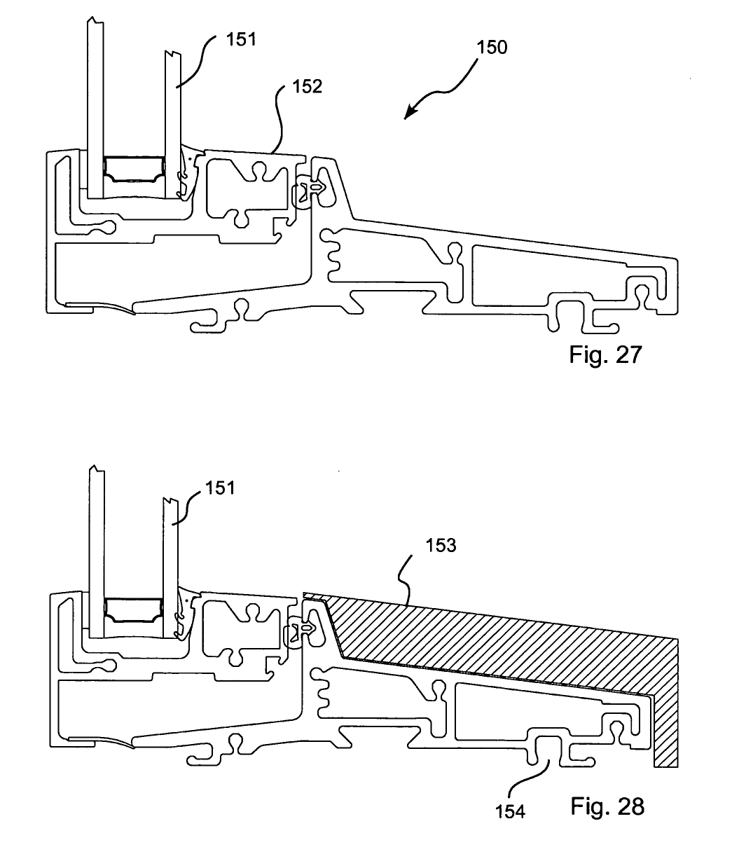

FIG. 27 shows a window assembly 150 according to the current invention with a double glazed 151 pane of glass. As can be seen by comparing FIGS. 3 and 27, it will be obvious that the only difference between the two embodiments, is the rearward position of the innermost pane of glass and the rearward portion 152 of the sash element. In other words the point of rotation of the windows is the same and the frame members are the same. The sash element is also the same, except that the outwardly facing surface of the U-shaped recess is placed further forwards in the double glazed version as in the triple glazed version. This allows the same mounting fittings, locking fittings, and frame members to be used with both the double glazed version of the sash and the triple glazed version of the sash. In addition, it is possible to start with a double glazed sash and then later on “upgrade” to a triple glazed sash without having to change any of the window frame members. This is also an advantage from a manufacturing point of view since fewer components have to be produced and/or held in stock. This could be considered a type of system of window assemblies, where the system comprises at least one type of frame profile and at least two different sash profiles, one for a double glazed pane and one for a triple glazed pane. The mounting fittings and locking fittings are the same for all windows in the system of window assemblies.

FIG. 28 shows the same embodiment as FIG. 27, but a trim element 153 has been mounted on the inside surface of the frame member in order to change the visual impression of the frame member. It can also be noted that as in FIG. 3 and FIG. 27, the embodiment shown in FIG. 28 has a channel 154 which can be used to hide cables. This can be useful in the case where motors or other forms of electronics, such as lights, etc are integrated into the window assembly.

FIG. 29 shows an embodiment 160 of a double glazed sash element 161 and a two piece frame member 162. The main portion 163 of the frame member is made from a solid piece of wood. This provides strength to the frame and allows the mounting fittings to be screwed into the wooden portion of the frame. The front portion 164 of the frame member is formed from a piece of ABS plastic which is formed as an extruded profile with an L shaped cross section. In this way, the part of the frame which is exposed to the outside environment is made from a weather resistant material and the inner portion of the frame member which is to be strong and which is visible on the inside of the window, is made from a strong and nice material. A seal 165 is co-extruded with the front portion 164 of the frame member.

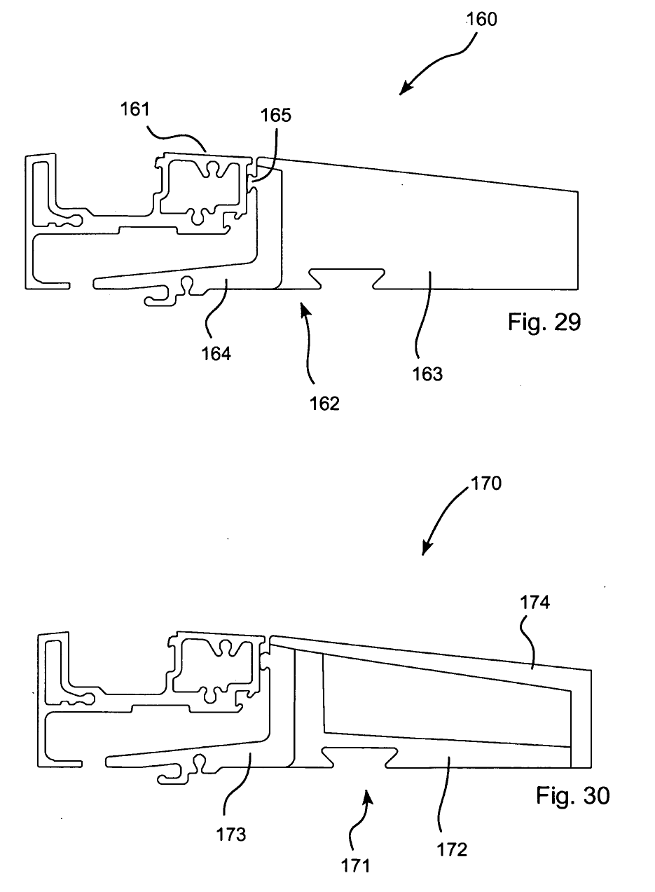

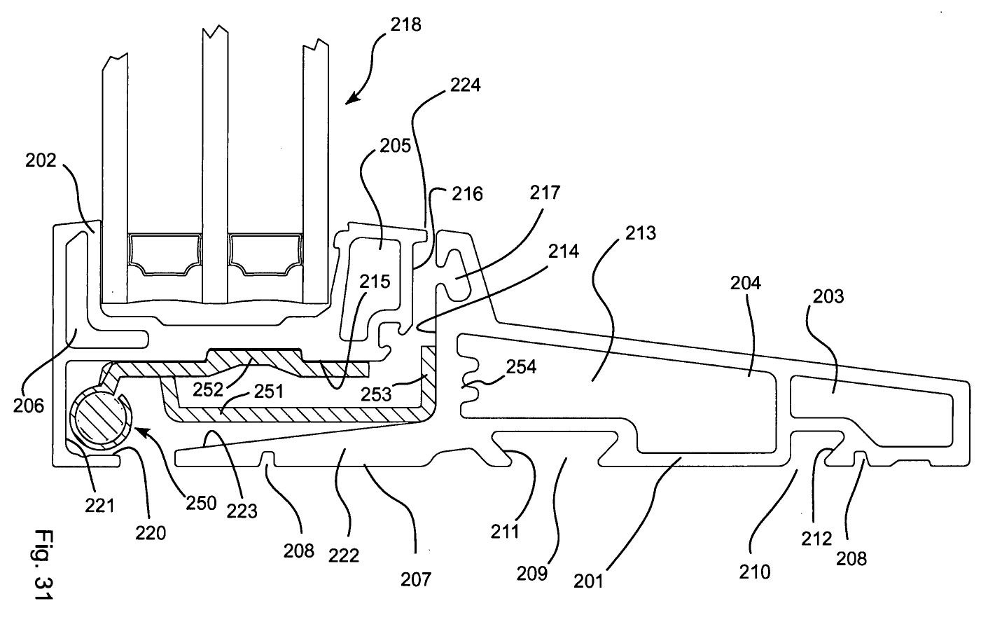

FIG. 30 shows an embodiment 170 of a window assembly where the frame member 171 comprises three elements: a strong inner portion 172 is made from a strong material such as glass fibre, a weak outer portion 173, similar to the outer portion of the embodiment of FIG. 29, which protects the frame from the outside environment is made from an ABS plastic material, and a nice looking inner trim piece 174 which can be mounted on the strong inner portion. In this way, the strong inner portion can be made from a strong and cheap material and the workers who are installing the window do not have to pay particular attention to how the frame member is treated. Once the frame member is installed, the trim piece can be applied to the frame member. The trim member can also be changed later on if a different visual impression is desired.

FIG. 31 shows another embodiment of a window assembly 200. For the sake of simplicity, only the frame member 201, the sash element 202 and a hinge 250 are shown. The frame member and the sash element are very similar to the ones shown in FIG. 2, however a number of significant differences exist.

The first main difference is that neither the frame member 201 nor the sash element 202 of the current embodiment have any screw holes. In the previous embodiment the screw holes were used for creating strong mitre joints. In contrast, in the current embodiment, when two frame members or two sash elements are to be joined together in a mitre joint glue is used instead. To explain the method used, the example of the sash is used, however the method will also work for the frame. A plug is inserted into a first cavity 205 of a first sash element. The plug is arranged to be placed at a certain distance into the cavity from the location of the joint and is arranged to close off the cross section of the cavity. In one example, the plug is placed 50 mm from the location of the joint. A second plug is inserted into a second cavity 205 of a second sash element which is to be joined to the first sash element. The second cavity corresponds to the first cavity. In this way, a cavity with a fixed depth is provided in each of the two sash elements which are to be joined together. One arm of an angle element (not shown) is then inserted into the first cavity in the first sash element. The two sash elements are then held together in a mitre joint. The second arm of the angle element (not shown) is thereby inserted into the second cavity in the second sash element. It should be noted that the first and second arms of the angle element can be made much smaller than the cavities in the first and second sash elements. In this way, the angle element is free to move around and is not firmly fixed to either cavity. This makes the assembly process very simple since the angle element is just placed in the cavity, without the need for any precise placement. In many prior art assemblies, the two arms of an angle element are inserted into two precisely fitted chambers of members which are to be joined. In certain prior art cases, barbs are placed on the arms such that once the arms have been inserted in corresponding cavities, the arms could not be removed again. However, in the current embodiment, the arms are just loosely placed in the cavities. Once the sash elements are held together, the two cavities of the sash elements join together to form a single enclosed volume. Glue is then inserted into this enclosed volume via a hole which is drilled into the cavity through an outer surface of one or both of the sash element(s). Enough glue is injected such that both cavities (up to the plugs) are completely filled. Once the glue has hardened, the angle element is firmly fixed in the joint and provides strength to the joint.

The angle element can be made from many different materials, for example glass fibre, aluminum, plastic, etc. It should also be noted that other cavities and/or more than one cavity per sash element/frame member could also be used to fix the angle element. The angle element could have many different forms, but a typical angle element will be an angle element having two arms of a certain length, for example 50 mm in the current embodiment, and being arranged at an angle of 90 degrees to each other. If the sash elements were joined at an angle other than 90 degrees, angle elements having other angles between the two arms could be used.

Another difference between this embodiment and the embodiment shown in FIG. 3 is that the surface 207 of the frame member which faces the periphery of the window assembly does not have any protrusions which protrude from the surface. This makes it easier to cut the frame members to the correct length. It also provides for a more uniform surface when supporting the surface on another surface. Two grooves 208 in the surface 207 are arranged to accept a seal element (not shown) for providing a back stop to a sealant bead. It can also be seen that the lower surface has a first complete dovetail groove 209 and a second groove 210 which is in the form of the rear half portion of a dovetail groove. In cases where a simple mounting needs to be made to the surface 207, a bracket (not shown) connected to the first dovetail groove 209 can be used. However, in cases where a stronger connection needs to be made to the surface 207, a bracket connected to the the forward surface 211 of the first dovetail groove 209 and the rear surface 212 of the second groove 210 can be used instead. In this way, a much stronger connection can be established due to the large distance between the forward surface 211 and the rearward surface 212.

It can also be seen that the box shaped portion 213 of the main portion of the frame member 201 is bigger than the box shaped portion of the embodiment of FIG. 3. This allows for more space inside the frame for other components such as motors, window shades, etc.

It should be noted that in the current embodiment, the hinge 250 is also attached to the outwardly facing surface 214 of the frame member and to the periphery facing surface 215 of the sash element. As in the previous embodiment, the outwardly facing surface 214 of the frame member is arranged opposite (or facing) an inwardly facing surface 216 of the sash element. The inwardly facing surface 216 of the sash element is arranged complementary to the outwardly facing surface 214 of the frame member. A seal element (not shown) connected to a groove 217 in the outwardly facing surface 214 of the frame member presses up against the inwardly facing surface 216 of the sash element. It can also be seen that the inwardly facing surface 216 of the sash element is arranged on the inside of the window pane 218. The outwardly facing surface 214 of the frame member is in this embodiment furthermore located entirely on the inside of the inwardly facing surface 216 of the sash element. In this case, the outwardly facing surface 214 is located entirely inside the innermost portion 224 of the sash element.

It can also be seen that the inwardly facing protrusion 219 of the sash element has an centre facing surface 220 and the sash element has an inside facing surface 221 arranged between the periphery facing surface 215 and the centre facing surface 220. Also, the forwardly protruding protrusion 222 of the frame member has a centre facing surface 223. The outward facing surface 214 and the centre facing surface 223 of the frame member and the periphery facing surface 215, the centre facing surface 220 and the inside facing surface 221 of the sash element together form an essentially enclosed cavity in which the mounting fittings can be arranged.

It can also be seen from FIG. 31, that the periphery facing surface 207 of the frame member is arranged closer to the periphery of the window assembly than the outwardly facing surface 216 to which the mounting fitting is fastened.

As can be seen from the figure, the hinge 250 has a first flange 251 which is fixed to the frame member. The hinge furthermore has a second flange 252 which is fixed to the periphery facing surface 215 of the sash element. The first flange 251 of the hinge is fixed to the frame member via a fourth flange 253 (the third flange is not shown in this cross section view). The fourth flange is fastened to the outwardly facing surface 214 of the frame member via a screw (not shown). The screw is placed through the fourth flange and is screwed into the thicker portion 254 of the frame member. In this embodiment, the point of connection between the hinge and the frame member is located on the inside of the sash element 202. By locating the point of connection on the inside of the sash element, the hinge can be screwed into the main body portion of the frame member. The main body portion of the frame member can be optimized for strength. This is in contrast to the majority of prior art solutions where the hinge would be attached to a protrusion which protrudes from an outwardly facing surface of the frame member which is arranged on the inside of the sash element. In the prior art solutions, the forwardly protruding protrusion to which the hinge is attached would have to be strengthened and would require an increase in the dimension of the frame member in the direction which is parallel to the plane of the window assembly. In the current embodiment, due to the point of attachment between the hinge and the frame member being located at a point which is on the inside of the sash element, the dimension of the frame can be reduced in the said direction. In an alternative and more restrictive formulation, the point of attachment between the hinge and the frame member is located at a point which is on or to the inside of a plane which is parallel to the plane of the window assembly and which includes the innermost edge of the sash element. It should be clear to the person skilled in the art that small deviations from this exact definition of the point of attachment should be included within the scope of this invention.

It can also be noted that the hinge 250 shown in the figures is of a type similar to the one shown in FIGS. 6 and 7, in other words, a hinge which is mounted at the corner of the window frame. While it cannot be seen in the cross section of FIG. 31, the hinge also comprises a third flange which extends perpendicularly from the first flange and a fifth flange which extends perpendicularly from the third flange. The fourth and fifth flanges are arranged co-planar and are both fastened to outwardly facing surfaces of the two frame members joined together at a corner. In this way, the hinge can be made very strong while at the same time providing a frame comprised of frame members having a rather low dimension in the direction parallel to the plane of the window and perpendicular to the longitudinal axis of the frame member.

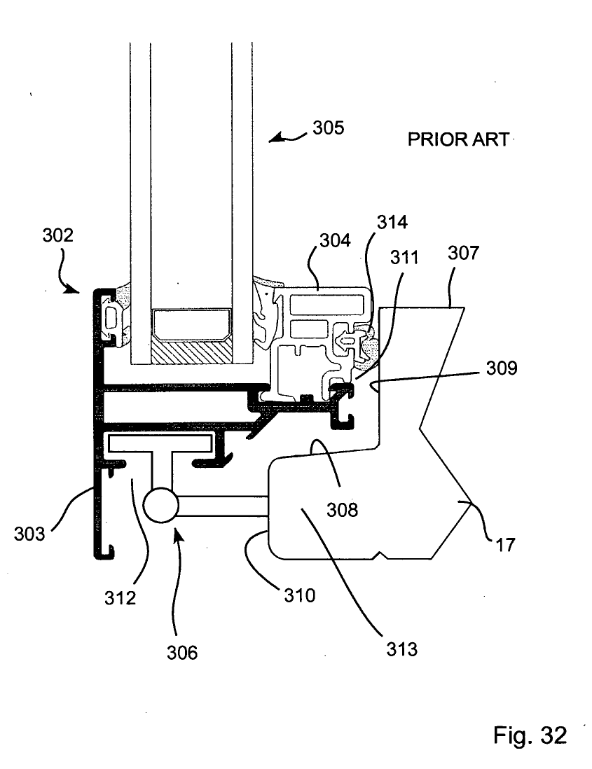

FIG. 32 shows a prior art window assembly 300 in order to describe in a little more detail, how the current invention is different from the prior art. This embodiment comprises a frame member 301 and a sash element 302 made up of a main sash profile 303 and a clip on glazing bead 304. A window pane 305 is held in place by the sash 302. A mounting fitting 306 holds the sash element in connection to the frame member. According to the understanding of the current specification, the frame member comprises a first centre facing surface 307, a second centre facing surface 308, a first outwardly facing surface 309 and a second outwardly facing surface 310. The sash element comprises a first inwardly facing surface 311 and a first periphery facing surface 312. The mounting fitting is attached to the frame member via the second outwardly facing surface 310 and to the sash element via the first periphery facing surface 312. It can also be noted that the first inwardly facing surface 311 of the sash element is facing and complementary to the first outwardly facing surface 309 of the frame member. A seal element 314 is arranged between these two surfaces.

It can be noted that the second centre facing surface 308 and the second outwardly facing surface 310 can be thought of as being surfaces of a forwardly protruding protrusion 313 protruding from the first outwardly facing surface 309 of the frame member.

It can also be noted that one could argue that surfaces 309, 308 and 310 were all part of a single surface, however, this is not in agreement with this specification since each of the three surfaces 309, 308 and 310 are uniquely identifiable surfaces.

The embodiments described above have shown a number of features which are interesting. These features could in many cases be the basis for divisional applications which are not dependent on all of the features of the window assembly disclosed in this specification. In particular, it should be noted that the corner hinges, the method of assembling the U shaped sash around the plate element, the design of the locking mechanism, the use of screw holes and the use of an angle element as described herein could all be the subject of divisional applications.

It should also be noted that the embodiments shown in the figures have all been outwardly opening windows. However, many of the inventions disclosed in this specification can also be used with inwardly opening windows or with windows which don't open at all or which slide open and closed. For example, the hinges, the arrangement of the screw holes to assemble the corners of the sash/frame, the method of assembling the sash/frame, the locking mechanism and the window brake disclosed herein could be used with either outwardly or inwardly opening windows.

It should also be mentioned that the system of window assemblies as described in the claims is claimed as dependent on the window construction described in the other claims. However, a divisional application related to a system as claimed but which is not dependent on the particular window assembly as described in the claims could also be imagined.

For the sake of completion of this specification, a number of additional phrases are listed below which could be used as literal basis for further independent or dependent claims. The phrases can be combined with other claims or with other phrases found in the description.

A hinge wherein the flanges are connected together via a pin arranged in cylindrical elements attached to the flanges.

A hinge wherein the portion of the flange which is arranged offset, is offset in the direction which is towards the inside of the window assembly in the closed position of the window assembly.

A hinge wherein the offset portion of the flange is a portion of the flange which is arranged between a first plane which is tangent to the surface of the pin or the surface of the cylindrical elements and parallel to the plane of the window assembly and a second plane which is arranged parallel to said first plane and offset from said first plane a distance of less than 10 mm and preferably less than 5 mm.

A window sash or a window frame comprising at least two window sash elements or window frame members respectively which are joined together via a mitre joint and where the window sash elements or the window frame members respectively each comprise at least three screw holes arranged along the longitudinal axis of the sash or frame members respectively and where the screw holes are arranged such that they do not lie on a single plane.

A window sash or window frame wherein at least one of the screw holes is located within 10 mm or within 5 mm of the outer periphery of the sash element or frame member respectively.

A window assembly wherein a portion (163) of the frame member is made from wood and that the outwardly protruding flange (164) is made from a different material.

A window sash comprising four sash elements surrounding a plate element, where each of the sash elements comprises an integrated U-shaped channel which surrounds one edge of the plate element, and where one surface of the plate element is fastened to one surface of the U-shaped channel via double sided tape.

A window sash wherein the surface of the plate element which is connected to the U-shaped channel is the outer surface of the plate element.

A window sash wherein the window sash further comprises a compressible seal element which is arranged between one surface of the plate element and one surface of the U-shaped channel.

A window assembly (160) wherein the outwardly protruding flange (164) of the frame member (162) is made from a plastic like material for example PVC.

1. An outwardly opening window assembly (1) for mounting in a window opening (27), said window assembly comprising:
a plate element (4),
a window sash (3) comprising a top sash element (3a), a bottom sash element (3c) and two side sash elements (3b,3d), said window sash elements arranged at the periphery of said plate element,
a window frame (2) comprised of a top frame member (2a), a bottom frame member (2c) and two side frame members (2b,2d), said window frame members arranged at the periphery of said window sash when the window assembly is closed,
a mounting fitting (5,6) which connects at least one of the window sash elements (3b) to at least one of the window frame members (2d),
characterized in that
one of the window frame members (2c) comprises a first surface (25) which faces towards the outside of the window assembly,
one of the window sash elements (3c) comprises a second surface (36) and a third surface (45), said second surface being arranged such that it is located on the inner side (44) of the plate element and such that it is facing said first surface (25) of said frame member when the window is closed, and said third surface being arranged such that it is facing the outer periphery (27) of the window assembly, and
said mounting fitting is fastened to said frame member via said first surface (25) and to said sash member via said third surface (45).

2. A window assembly (1) according to claim 1, characterized in that said first surface (25) of said frame member (2c) is arranged closer to the inner side of the window assembly than the second surface (36) and/or the innermost surface of the sash element (3c) in the closed position of the window.

3. A window assembly (1) according to claim 1, characterized in that said window frame member (2c) further comprises an outwardly protruding flange (24) which protrudes from said first surface (25) and in that said outwardly protruding flange comprises a fourth surface (37) which faces said third surface (45) of said window sash element 3c) when the window is closed.

4. A window assembly (1) according to claim 3, characterized in that the outermost edge of the outwardly protruding flange (24) protrudes past the inner surface (44) of the plate element (4) in the direction towards the outside of the window assembly.

5. A window assembly (1) according to claim 3, characterized in that the window frame member (2d) and the mounting fittings (5,6) are designed such that less than 20% of the weight of the window sash (3) which is transferred to the window frame (2) is supported by the outwardly protruding flange (24), preferably less than 10% of the weight of the window sash which is transferred to the window frame is supported by the outwardly protruding flange and most preferably none of the weight of the window sash which is transferred to the window frame is supported by the outwardly protruding flange.

6. A window assembly (1) according to claim 3, characterized in that said outwardly protruding flange (24) of the frame member (2c) is arranged essentially perpendicular to the first surface (25) of the frame member.

7. A window assembly (1) according to claim 1, characterized in that the frame member (2c) comprises a fifth surface (26) which is arranged at the periphery of the window assembly and which faces towards the sides of the window opening (27) when the window assembly is mounted in a window opening, said fifth surface being arranged for being connected to the sides of a window opening.

8. A window assembly (1) according to claim 7, characterized in that the first surface (25) and the fifth surface (26) of the frame member (2d) are rigidly connected to each other such that the loads due to the window sash (3) which are transferred from the third surface (45) of the sash element (3b) to the first surface (25) of the frame member via the mounting fittings are transferred from the first surface of the frame member to the fifth surface of the frame member.

9. A window assembly (1) according to claim 2, characterized in that the first surface (25) and the fourth surface (37) of the frame member (2c) are surfaces of an integrally formed element.

10. A window assembly (1) according to claim 2, characterized in that the length of the outwardly protruding flange (24) of the frame member is greater than 50% of the width of the sash element (2c) and preferably greater than 75% of the width of the sash element.

11. A window assembly (1) according to claim 1, characterized in that one of the sash elements (3c) comprises an inwardly protruding flange (50) which is located closer to the periphery of the window assembly than the third surface (45) of the sash element and extends in a direction which is essentially perpendicular to the plane of the plate element (4) and in a direction towards the inside of the window assembly when the window is closed.

12. A window assembly (1) according to claim 11, characterized in that the inwardly protruding flange (50) of the sash element (3c) is the part of the sash element which is located closest to the periphery of the window assembly.

13. A window assembly (1) according to claim 11, characterized in that the innermost edge of the inwardly protruding flange (50) of the sash element (3c) is located closer to the inside of the window assembly than the outer surface (41) of the plate element (4).

14. A window assembly (1) according to claim 11, characterized in that the outwardly protruding flange (24) of the frame member (2c) and the inwardly protruding flange (50) of the sash element (3c) are arranged co-planar when the window assembly is closed.

15. A window assembly (1) according to claim 14, characterized in that distance between the innermost edge of the inwardly protruding flange (50) of the sash element (3c) and the outermost edge of the outwardly protruding flange (24) of the frame member (2c) is less than 10 mm, preferably less than 5 mm and most preferably less than 2 mm when the window assembly is closed.

16. A window assembly (1) according to claim 11, characterized in that said first surface of the frame member, said third surface of the sash element, said fourth surface of the forwardly protruding flange of the frame member, said inwardly protruding flange of said sash element and an inwardly facing surface of the sash element arranged between the third surface and the inwardly protruding flange form parts of an essentially enclosed cavity in which the mounting fittings can be arranged.

17. A window assembly (1) according to claim 1, characterized in that the frame member (2c) comprises a sixth surface (33) which faces in towards the centre of the window assembly and which is the surface of the frame member which is arranged closest to the centre of the window assembly and in that the sash element (3c) comprises a seventh surface (34) which faces in towards the centre of the window assembly and which is located on the inside of the plate element and in that said sixth and seventh surface are arranged co-planar in the closed position of the window assembly.

18. A window assembly (1) according to claim 1, characterized in that the frame member (2c) and/or the sash element (3c) is made via a pultrusion process where the material is a composite material with a matrix which is polyurethane based and with at least 80% of the material by volume being comprised of fibres which are arranged parallel to the longitudinal axis of the frame member.

19. A window assembly (1) according to claim 1, characterized in that the sash element (3c) comprises an integrated U shaped recess (40) in which an edge of the plate element (5) is arranged when the plate element is attached to the sash element.

20. A window assembly (1) according to claim 19, characterized in that one surface of the plate element is fastened to one surface of the U-shaped channel via double sided tape.

21. A window assembly (1) according to claim 1, characterized in that the cross sections of the four sash elements (3a,3b,3c,3d) and/or the cross sections of the four frame members (2a,2b,2c,2d) taken perpendicular to the longitudinal axis of each of the four sash elements and/or frame members respectively are essentially the same.

22. A window assembly according to claim 1, characterized in that said mounting fitting is a hinge, said hinge comprising a first flange fixed to the window frame and a second flange fixed to the window sash and where the two flanges are pivotably connected to each other about a pivot axis, and where said hinge further comprises a third flange which is arranged perpendicular to the first flange and at the end of the first flange opposite to the end of the first flange which is pivotably connected to the second flange and where the third flange is fastened to the first surface of the frame member at a point which is located inside the sash element.

23. A window assembly according to claim 22, characterized in that said first flange of said hinge is arranged essentially perpendicular to the first surface of the frame member and is arranged closer to the periphery of the window assembly than the point at which the third flange is fastened to the first surface of the frame member.

24. A window assembly according to claim 22, characterized in that said hinge further comprises a fourth flange which is arranged perpendicular to the first flange and which is fixed to a second frame member which is arranged perpendicular to the frame member.

25. A window assembly according to claim 24, characterized in that said hinge further comprises a fifth flange which is attached to and arranged perpendicular to the fourth flange and which is fastened to an outwardly facing surface of the second frame member.

26. A system of window assemblies (1,150) having a first window assembly (150) and a second window assembly (1), each according to claim 1, wherein the first window assembly comprises a double glazed plate element, and the second window assembly (1) comprises a triple glazed plate element, characterized in that the frame members (3a,3b,3c,3d) of the first and the second window assemblies are essentially identical and the distance from the outermost surface (41) of the double glazed plate element (5) in the first window assembly to the inner most surface (36) of the sash element (3c) is the same as the distance from the outermost surface (41) of the triple glazed plate element in the second window assembly to the innermost surface (36) of the sash element (3c).

27. A system of window assemblies (1,150) according to claim 26, characterized in that the window sash (3) of the first window assembly (150) is attached to the frame (3) via at least one hinge (5,6) and in that the window sash (3) of the second window assembly (1) is attached to the frame (2) via at least one hinge (5,6), and in that the axis of rotation of the window sash in the first window assembly with respect to the frame member is the same as the axis of rotation of the window sash in the second window assembly.
